(19) United States
(12) Patent Application Publication
(10) Pub. No.: US 2004/0258006 A1
(43) Pub. Date: Dec. 23, 2004

(54) Apparatus and method for communicating between devices without a piconet coordinator in a piconet

(75) Inventor: Cheol-hong An, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/858,446

(22) Filed: Jun. 2, 2004

Related U.S. Application Data
(60) Provisional application No. 60/490,944, filed on Jul. 30, 2003.

(30) Foreign Application Priority Data
Jun. 3, 2003 (KR) 10-2003-0035775

(51) Int. Cl. H04B 7/00; G06F 15/173

(52) U.S. Cl. 370/310; 709/244

(57) ABSTRACT

The present invention relates to an apparatus and method enabling transmission and reception of data between wireless network devices in an ad hoc network-based piconet without a piconet coordinator (PNC). The apparatus for transmitting and receiving data between wireless devices according to the present invention includes a beacon generator module for constructing a virtual piconet by generating a beacon so that a device lacking a PNC function can perform a virtual PNC function; and a virtual PNC termination module for shutting down the virtual piconet when association of a PNC-capable device with the virtual piconet is present in the virtual piconet.

This application claims the priorities of Korean Patent Application No. 2003-35775 filed on Jun. 3, 2003, with the Korean Intellectual Property Office, and U.S. Provisional Application No. 60/490,944 filed on Jul. 30, 2003, with the United States Trademark and Patent Office, the disclosures of which are incorporated herein in its entirety by reference.

### BACKGROUND OF THE INVENTION

1. Field of Invention

The present invention relates to an apparatus and method for enabling efficient transmission and reception of data between wireless network devices, and more particularly, to an apparatus and method for enabling transmission and reception of data between wireless network devices in an ad hoc network-based piconet without a piconet coordinator (PNC).

2. Description of the Related Art

With the development and popularization of digital technologies, increasingly a large number of digital products have become available on the market. Many digital products such as DVD players, cable set-top boxes, digital video cassette recorders, digital TV (DTV) sets and personal computers are connected by one network. The development of wireless communication technology leads attempts to connect such devices in a wireless manner rather than by wires.

In communications on a wireless personal area network (PAN), all devices in a piconet defined by the existing IEEE 802.15.3 can gain access to a wireless medium (WM) depending on information provided by a PNC. The information is broadcast through a beacon. One piconet is determined according to a piconet ID (PNID) and a beacon source ID (BSID) that are defined by the PNC. The PNC further provides many significant functions as shown in the figures, and these functions may exist in one device in the same manner as one device function.

As shown in FIG. 1, the PNC provides a method and management for enabling devices to share one wireless medium, and the PNC plays an important role in the piconet. However, the complex functions of the PNC require a great deal of hardware and software resources. Accordingly when the existing piconet is applied to universal serial bus (USB) devices or wireless 1394, a method by which resources can be more efficiently utilized and functions of a PNC are provided, is in need, even though such a conventional PNC is not used.

### SUMMARY OF THE INVENTION

The present invention is conceived in consideration of the foregoing. An object of the present invention is to provide a virtual PNC apparatus for enabling nodes to share a wireless medium through transaction scheduling of an upper layer without using a PNC in an ad hoc network consisting of the nodes, each of which lacks a PNC function of a conventional wireless PAN.

Another object of the present invention is to provide a method for enabling such a virtual PNC to be compatible with a conventional piconet with a PNC.

A further object of the present invention is to provide an apparatus and a method, wherein one of different virtual PNCs is provided depending on whether a master-slave scheme is used or whether a peer-to-peer scheme is used in order to ensure compatibility, and wherein the virtual PNC is not activated in the presence of a PNC.

According to one aspect of the present invention for achieving the objects, there is provided an apparatus for transmitting and receiving data between wireless devices, comprising a beacon generator module for constructing a virtual piconet by generating a beacon so that a device lacking a PNC function can perform a virtual PNC function; and a virtual PNC termination module for shutting down the virtual piconet when association of a PNC-capable device with the virtual piconet is present in the virtual piconet.

According to another aspect of the present invention, there is provided a piconet system constructed by a plurality of devices, wherein one of the devices includes a virtual PNC; and the virtual PNC comprises a beacon generator module for constructing a virtual piconet by generating a beacon so that a device lacking a PNC function can perform a virtual PNC function; and a virtual PNC termination module for shutting down the virtual piconet when association of a PNC-capable device with the virtual piconet is present in the virtual piconet.

According to a further aspect of the present invention, there is provided a method comprising the steps of scanning an open channel; determining whether a beacon exists based on the results of the scan of the open channel; if it is determined that a beacon exists, performing association with a PNC in a piconet; and if it is determined that a beacon does not exist, determining whether an apparatus can operate as a PNC.

### BRIEF DESCRIPTION OF THE DRAWINGS

The above and other objects and features of the present invention will become apparent from the following description of preferred embodiments given in conjunction with the accompanying drawings, in which:

FIG. 1 is a schematic block diagram of a conventional piconet with a PNC, which is implemented with USB devices;

FIG. 2 is a schematic block diagram of a piconet with a virtual PNC according to the present invention, which is implemented with USB devices;

FIG. 3 is a schematic block diagram showing the arrangement and operations of modules for implementing the virtual PNC according to the present invention;

FIG. 4 shows PNC-executable commands and virtual PNC-executable commands among all commands provided by IEEE 802.15.3;

FIG. 5A shows the structure of a superframe that a conventional PNC transmits to member devices of a piconet during a beacon period;

FIG. 5B shows the structure of a superframe that the virtual PNC of the present invention transmits to member devices of the piconet during the beacon period, when using a peer-to-peer scheme;

FIG. 5C shows the structure of a superframe that the virtual PNC of the present invention transmits to the member devices of the piconet during the beacon period, when using a master-slave scheme; and

FIG. 6 is a flowchart illustrating the overall operation of the piconet to which the virtual PNC of the present invention is applied.

### DETAILED DESCRIPTION OF THE INVENTION

Hereinafter, preferred embodiments of the present invention will be described in detail with reference to the accompanying drawings.

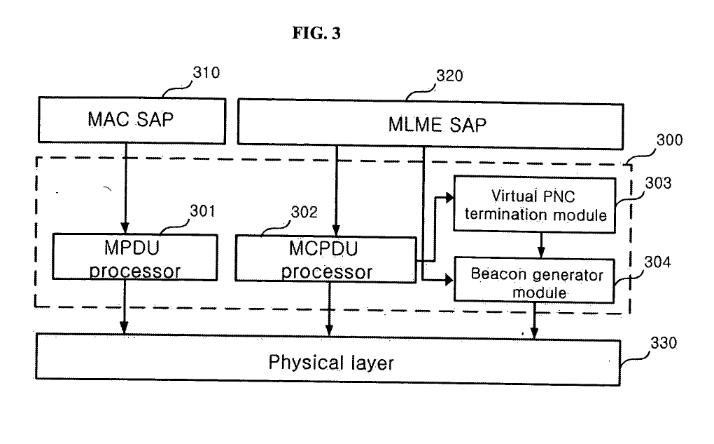

FIG. 2 is a schematic block diagram of a piconet 200 with a virtual PNC 240 according to the present invention, which is implemented with USB devices 210, 220 and 230. A PNC is a node indispensable to the establishment of one piconet. The wireless USB host 210 and wireless USB devices 220 and 230 require association with the PNC to be members of the piconet. The wireless USB host 210 is a control device for making all transactions between itself and the wireless USB devices 220 and 230, scheduling the transactions, and executing wireless USB applications. In addition, the wireless USB devices 220 and 230 perform necessary operations depending on commands issued from the wireless USB host 210, and provide device functions to the wireless USB applications.

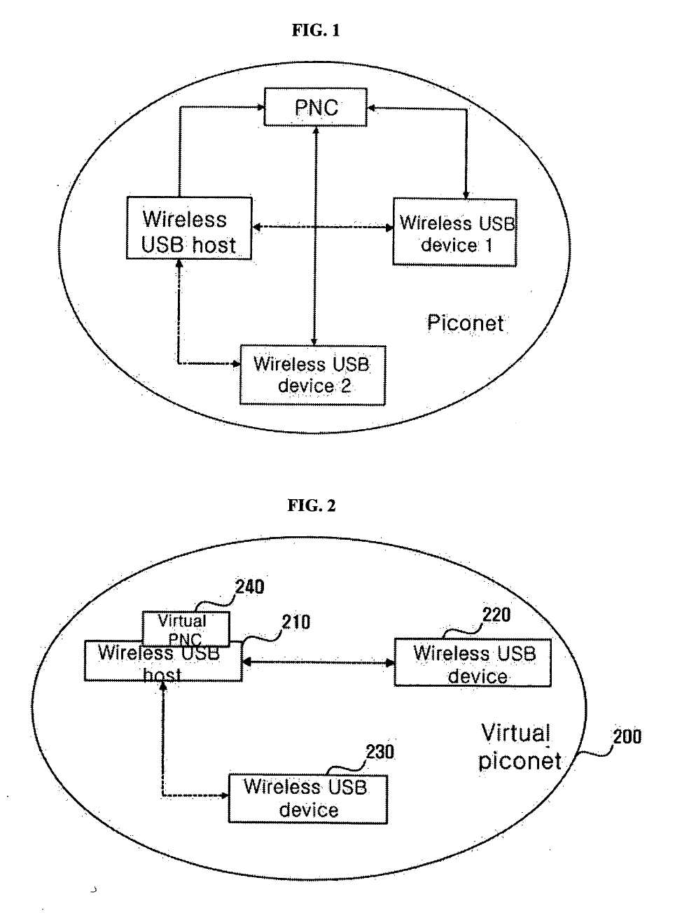

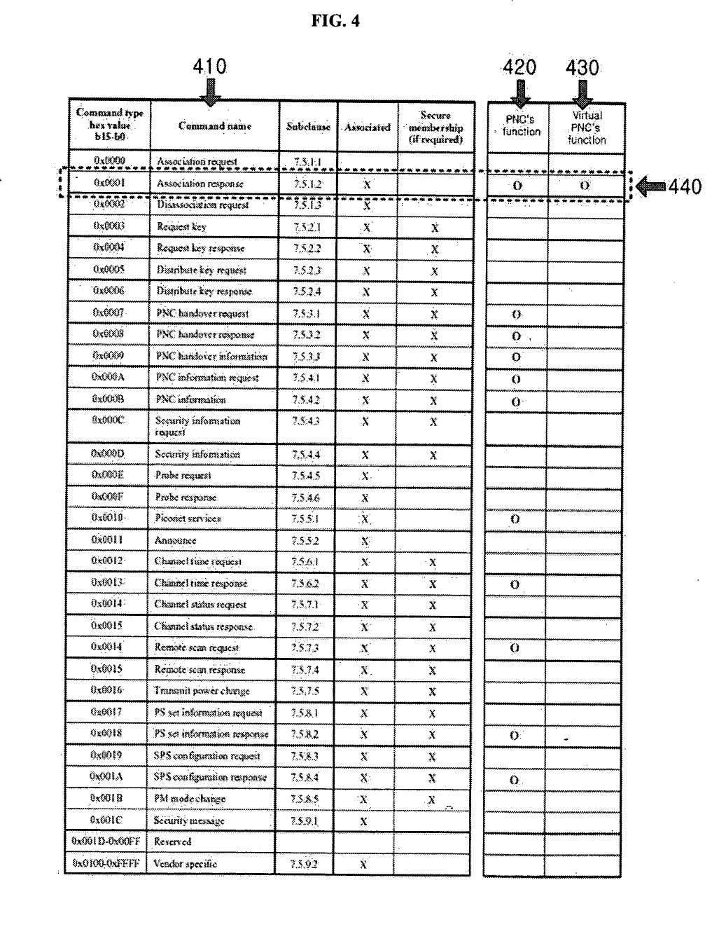

According to the present invention, the PNC function is serviced by a virtual PNC 240 that substitutes for such a conventional PNC. Contrary to FIG. 1, a PNC does not exist and the wireless USB host 210 has a virtual PNC generating device (designated by reference numeral 300 in FIG. 3) therein to perform the function of the virtual PNC 240. As a result, a collection of the wireless USB host 210 with the virtual PNC function and the wireless USB devices 220 and 230 establishes a virtual piconet 200. If an actual PNC exists, the virtual piconet 200 shuts down the function of the virtual PNC 240, and establishes a piconet together with the actual PNC. Thus, the virtual piconet 200 of the present invention is compatible with an existing piconet with an actual PNC. Although FIG. 2 shows, by way of example, a case of an USB employing a master-slave scheme, the present invention is also applicable to IP networking or wireless 1394 based on a peer-to-peer scheme. Since the peer-to-peer scheme has devices with an equal relationship therebetween rather than a master-slave relationship, the PNC generating device (designated by reference numeral 300 in FIG. 3) may be incorporated into one of the devices.

FIG. 3 is a schematic block diagram showing the arrangement and operations of modules for implementing the virtual PNC according to the present invention. A media access control (MAC) SAP 310 means a MAC server access point enabling a MAC layer to transmit and receive data to and from an upper layer thereof, and a MLME SAP 320 is a service access point for a management entity in the MAC layer.

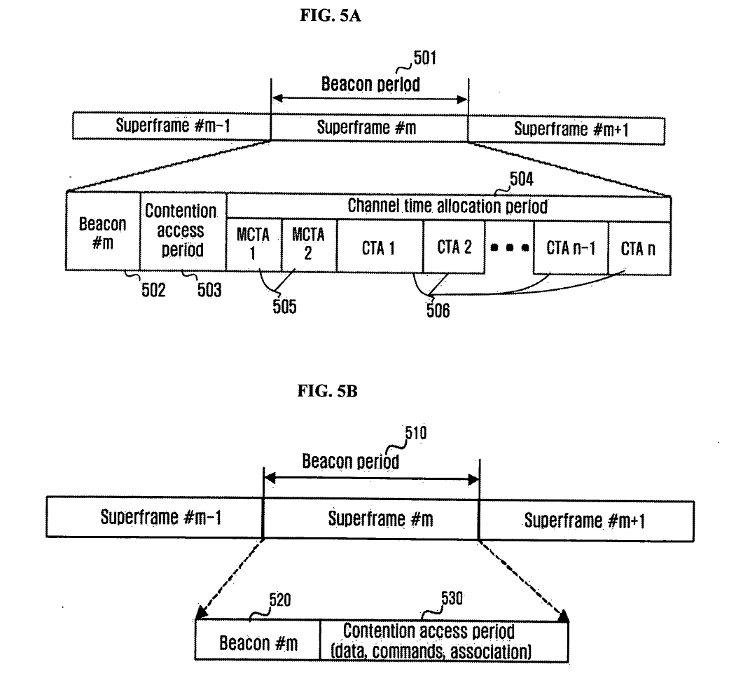

The virtual PNC generating device 300 transmits and receives data to and from the MAC SAP 310, the MLME SAP 320 and a physical layer 330, and may comprise a MAC protocol data unit (MPDU) processor 301, a MAC command protocol data unit (MCPDU) processor 302, a virtual PNC termination module 303 and a beacon generator module 304. One reason for the inevitable presence of a PNC in a piconet is that the PNC has a function of fixing members of the piconet depending on the connection or disconnection of each device to and from the piconet, i.e. a function of receiving association requests from the devices and returning association responses. In the absence of a PNC, the virtual PNC generating device 300 of the present invention has only the function of issuing responses to association requests among the many functions of the PNC shown in FIG. 4. Accordingly, in an ad hoc network consisting of nodes that lack a PNC function of a conventional wireless PAN, a wireless medium can be shared by nodes through transaction scheduling of the upper layer without a PNC, thereby greatly saving hardware and software resources.

The MPDU processor 301 is responsible for the function of processing a MAC protocol data unit (MPDU), and the MCPDU processor 302 is responsible for the function of processing a MAC command protocol data unit (MCPDU), both of which are modules used in the related art.

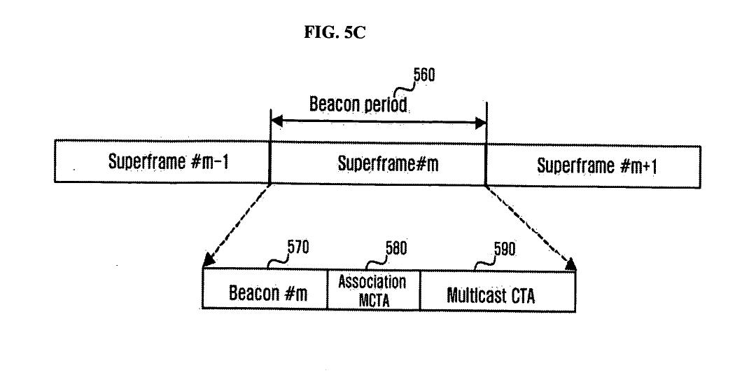

The beacon generator module 304 generates a beacon that enables a device lacking a PNC function to perform the virtual PNC function of the present invention. A superframe constructed by the generated beacon has a structure shown in FIG. 5B or 5C. The beacon includes information on a contention access period (CAP), information on management channel time allocation (MCTA) for association, information on CTA for multicast or broadcast, and an application specific information element for representing a virtual PNC. If the virtual piconet is shut down, the beacon further includes a shut-down information element.

The virtual PNC termination module 303 serves to disable the virtual PNC function. The virtual PNC termination module 303 receives information on the presence of PNC-capable association from the MCPDU, shuts down the virtual piconet, and instructs the beacon generator module 304 to inform other devices of the occurrence of this event.

The virtual PNC generator device having the aforementioned features may be implemented with an application in the upper layer of the MAC layer, or with hardware.

FIG. 4 shows PNC-executable commands and virtual PNC-executable commands among all commands provided by IEEE 802.15.3. The following description will focus on a command name column 410 listing commands executable by all devices in the piconet, a PNC function column 420 in which PNC-executable commands are checked, and a virtual PNC function column 430 in which virtual PNC-executable commands are shown.

The PNC can execute a number of functions as listed, such as a PNC handover request, a PNC handover response and a channel time response as well as the association response. However, the virtual PNC has only the association response function by which when a new device requests association with the virtual piconet, a response to the association request is issued (refer to 440 in FIG. 4).

FIG. 5A shows the structure of a superframe that a conventional PNC transmits to member devices of a piconet during a beacon period (501). According to IEEE 802.15.3, a MAC frame is put into the superframe with a time-based structure, as shown in this figure.

The beacon has a section 502 in which a beacon serial number is recorded, and a subsequent section 503 for indicating a contention access period (CAP). The CAP means a period in which the time of transmission/reception of data by devices is determined through a contention scheme such as carrier sense multiple access/collision avoidance (CSMA/CA). The CAP does not necessarily exist in the superframe but may be omitted depending on the piconet structure or by user determination. Next, there is a section 506 for indicating a contention time allocation (CTA) period. MCTAs 505 are distributed to respective devices within the CTA period. Here, the MCTA means a management CTA 441.

FIG. 5B shows the structure of a superframe that the virtual PNC of the present invention transmits to member devices of the piconet during the beacon period 510, when using a peer-to-peer scheme. The superframe may also have a section 520 in which a beacon serial number is recorded and a subsequent section 530 for indicating a CAP, in the same manner as the superframe of the conventional PNC.

Individual devices employing the peer-to-peer scheme, i.e. devices in IP networking, wireless 1394 or the like, can independently perform one packet transaction. According to this embodiment, the CAP using the CSMA/CA is allocated during the beacon period. Accordingly, each device transmits and receives association, data and commands through the CSMA/CA contention scheme during the CAP.

FIG. 5C shows the structure of a superframe that the virtual PNC of the present invention transmits to the member devices of the piconet during the beacon period, when a master-slave scheme is used. The superframe also has a section 570 in which a beacon serial number is recorded, and a section for allocating association MCTA or CAP so that a new slave device can be associated with the virtual PNC (in this embodiment, section 580 for allocating the association MCTA).

Since the wireless USB host performs scheduling of all wireless media in devices employing the master-slave scheme, such as wireless USB, CTAs having multicast or broadcast destinations are used to transmit data and commands. According to this embodiment, a multicast CTA section 590 is placed after the association MCTA section so that the multicast CTA can be used.

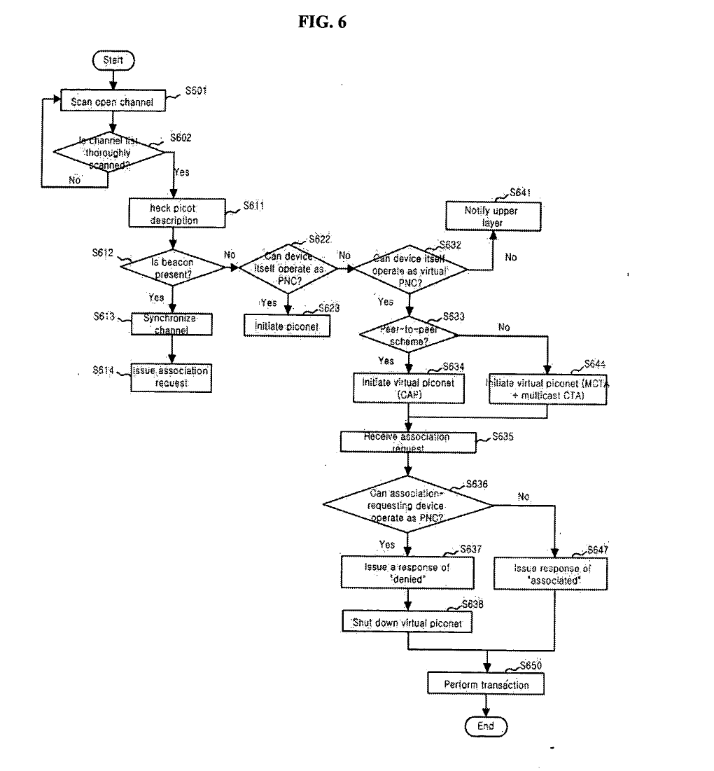

FIG. 6 is a flowchart illustrating the overall operation of the piconet to which the virtual PNC of the present invention is applied.

A method of the present invention that enables devices to communicate with one another in a piconet lacking a PNC shown in FIG. 2 will be described by way of example in connection with a wireless USB application. As shown in FIG. 6, one device first scans channels present on a wireless medium (S601). At this time, an open scan in which a desired piconet is not specifically designated may be conducted, or only a specifically designated piconet may be scanned. In this embodiment, the open scan is employed and the presence of a beacon is passively detected without probing the presence of a PNC. A channel list to be checked is thoroughly checked (S602). As a result, it is possible to know which channel has a beacon, based on the piconet description (S611).

It is determined whether a beacon is present in a channel (S612). If it is determined that a beacon is present in the channel (S612), the channel is synchronized through synchronization (S613) and association with a piconet of the desired channel is conducted and the device is operated as a member device in the piconet (S614). If it is determined that a beacon does not exist, it is determined whether the device itself can construct a piconet, i.e. the device can operate as a PNC (S622). If the device can operate as the PNC, the device constructs its own piconet and functions as both the PNC and a device in the piconet (S623). However, if the device cannot operate as a PNC, it is checked whether the device can operate as a virtual PNC (S632).

If it is checked that the device cannot operate as a virtual PNC, an upper layer is notified of this fact (S641). Then, the upper layer will determine the following actions. For example, the upper layer may wait for the appearance of a device serving as a PNC or virtual PNC, or select a different communication method.

If it is checked that the device can operate as a virtual PNC, the following steps will be determined depending on features of an application of the upper layer (S633). If the application of the upper layer is based on the peer-to-peer scheme such as IP networking or wireless 1395, each device can individually perform one packet transaction. Therefore, a wireless medium needs to be shared by respective devices. Access to the wireless medium can be gained through CSMA/CA or a “Slotted Aloha” method that enables reduction in conflict risk by time division channel allocation. In the present embodiment, the CAP using CSMA/CA is allocated during the beacon period (S634). In this case, the superframe will have the structure shown in FIG. 5B, contrary to the typical structure of a superframe used in case of the presence of a PNC shown in FIG. 5A.

On the contrary, if the application is based on the master-slave scheme, the wireless USB host performs the scheduling of all wireless media, as in a wireless USB. Therefore, it is possible to allocate association MCTA or CAP for association of a new device. In this embodiment, the association MCTA is employed. For the transmission of data and commands, CTAs having multicast or broadcast destinations are allocated to the remainder of the beacon period. In this embodiment, the superframe will have a structure as shown in FIG. 5C, contrary to the typical structure of a superframe used in the presence of a PNC shown in FIG. 5A.

When the virtual piconet is constructed by transmitting such a beacon, a new device issues an association request so as to become a member of the piconet (S635). It is determined whether the new device can operate as a PNC (S636). If so, an association response of “denied” is returned (S637) to shut down the piconet (S638). The piconet shut-down procedure includes incorporating a shut-down information element into the beacon. If the device cannot operate as a PNC, an association response of “associated” is returned (S647).

Finally, when using devices based on IP networking or wireless 1395, transactions are performed in the peer-to-peer scheme. In case of wireless USB devices, the host device performs application transactions with the wireless USB devices (S650).

Although the present invention has been described in detail in connection with exemplary embodiments of the present invention, the present invention is not limited thereto. It will be apparent to those skilled in the art that various changes and modifications may be made thereto without departing from the technical spirit and scope of the invention.

According to the present invention, there are advantages in that communications can be made among devices by using a virtual PNC with simplified functions even in a piconet lacking a PNC, and compatibility with an existing piconet with a PNC can be ensured.

Further, there is an advantage in that it is possible to reduce the burden on implementation of the PNC function that requires a large amount of hardware or software resources.

Although the present invention has been described in detail in connection with exemplary embodiments of the present invention, the present invention is not limited thereto. It will be apparent to those skilled in the art that various changes and modifications may be made thereto without departing from the technical spirit and scope of the invention.

What is claimed is:

1. An apparatus for transmitting and receiving data between wireless devices, comprising:
a beacon generator module for constructing a virtual piconet by generating a beacon so that a device lacking a piconet coordinator (PNC) function can perform a virtual PNC function; and
a virtual PNC termination module for shutting down the virtual piconet when association of a PNC-capable device with the virtual piconet is present in the virtual piconet.

2. The apparatus as claimed in claim 1, further comprising:
a media access control (MAC) protocol data unit (MPDU) processor responsible for a function of processing MAC protocol data units; and
a MAC command protocol data unit (MCPDU) processor responsible for the function of processing MAC command protocol command data units and transferring the association to the virtual PNC termination module when the association of the PNC-capable device exists.

3. The apparatus as claimed in claim 1, wherein if an application of a device including a virtual PNC is based on a peer-to-peer scheme, a superframe generated by the beacon generator module includes a contention access period (CAP) section.

4. The apparatus as claimed in claim 3, wherein the CAP section indicates a section in which a carrier sense multiple access/collision avoidance (CSMA/CA) scheme is used when transmission and reception of data and commands and the association are performed.

5. The apparatus as claimed in claim 3, wherein the CAP section indicates a section in which a Slotted Aloha scheme is used when transmission and reception of data and commands and the association are performed.

6. The apparatus as claimed in claim 1, wherein if an application of a device comprising the virtual PNC is based on a master-slave scheme, a superframe generated by the beacon generator module includes an association management channel time allocation (MCTA) section and a multicast channel time allocation (CTA) section.

7. A piconet system comprising a plurality of devices, wherein:
at least one of the plurality of devices comprises a virtual piconet coordinator (PNC); and
the virtual PNC comprises:
a beacon generator module for constructing a virtual piconet by generating a beacon such that a device lacking a PNC function can perform a virtual PNC function; and
a virtual PNC termination module for shutting down the virtual piconet when association of a PNC-capable device with the virtual piconet is present in the virtual piconet.

8. The system as claimed in claim 7, wherein the virtual PNC comprises:
a media access control (MAC) protocol data unit (MPDU) processor responsible for the function of processing MAC protocol data units; and
a MAC command protocol data unit (MCPDU) processor responsible for a function of processing MAC command protocol command data units.

9. The system as claimed in claim 7, wherein if an application of a device comprising the virtual PNC is based on a peer-to-peer scheme, a superframe generated by the beacon generator module includes a contention access period (CAP) section.

10. The system as claimed in claim 7, wherein if an application of a device comprising the virtual PNC is based on a master-slave scheme, a superframe generated by the beacon generator module includes an association management channel time allocation (MCTA) section and a multicast channel time allocation (CTA) section.

11. A method of transmitting and receiving data between wireless devices, comprising:
(a) determining whether an application resident in an upper layer of a media access control (MAC) layer is based on a peer-to-peer scheme;
(b) initiating a virtual piconet depending on the determination results;
(c) receiving an association request from one of the wireless devices by a virtual piconet coordinator (PNC) in the virtual piconet; and
(d) performing an application transaction with said one of the wireless devices that has issued the association request.

12. The method as claimed in claim 11, wherein the step (b) comprises the step of determining whether the application is based on the peer-to-peer scheme, and if it is determined that the application is based on the peer-to-peer scheme, a superframe generated by the virtual PNC comprises a contention access period (CAP) section.

13. The method as claimed in claim 11, wherein the step (b) comprises the step of determining whether the application is based on the peer-to-peer scheme, and if it is determined that the application is not based on the peer-to-peer scheme, a superframe generated by the virtual PNC includes an association management channel time allocation (MCTA) section and a multicast CTA section.

14. The method as claimed in claim 11, after the step (c), further comprising the step of determining whether said one of the wireless devices that has issued the association request can operate as a PNC.

15. The method as claimed in claim 14, further comprising the steps of, if it is determined that said one of the wireless devices can operate as the PNC,
sending an association-denying response to the device that has issued the association request; and
shutting down the virtual piconet.

16. The method as claimed in claim 15, wherein the step of shutting down the virtual piconet comprises the step of incorporating a shut-down information element into a beacon.

17. The method as claimed in claim 14, further comprising the steps of, if it is determined that said one of the wireless devices cannot operate as the PNC,
maintaining the virtual piconet as it is and sending a response of “associated” to said one of the wireless devices that has issued the association request.

18. The method as claimed in claims 11, before the step (a), further comprising the steps of:
determining whether a beacon is detected in an existing device, and performing association with a piconet coordinator (PNC) that has generated the beacon if it is determined that the beacon exists, or determining whether the existing device can operate as a PNC if the beacon is not detected;
performing one of initiating an actual piconet if it is determined that the existing device can operate as the PNC, and determining whether the existing device can operate as a virtual PNC if it is determined that the existing device cannot operate as the PNC; and
if it is determined that the existing device cannot operate as the virtual PNC, notifying the upper layer of the fact, and if it is determined that the existing device can operate as the virtual PNC, proceeding to the step (a).
